(19) United States
(12) Patent Application Publication
(10) Pub. No.: US 2011/0051109 A1
(43) Pub. Date: Mar. 3, 2011

(54) MEASUREMENT APPARATUS, EXPOSURE APPARATUS, AND DEVICE MANUFACTURING METHOD

(75) Inventors: Keiji EMOTO, Utsunomiya-shi (JP); Ryo TAKAI, Utsunomiya-shi (JP)

(73) Assignee: CANON KABUSHIKI KAISHA, Tokyo (JP)

(21) Appl. No.: 12/872,361

(22) Filed: Aug. 31, 2010

(30) Foreign Application Priority Data
Aug. 31, 2009 (JP) 2009-201083

(51) Int. Cl. G03B 27/42; G01B 11/14; G03B 27/32

(52) U.S. Cl. 355/53; 356/614; 355/77

(57) ABSTRACT

A measurement apparatus which includes a plurality of sensors arranged on a movable member, and a plurality of scales attached to a structure, and measures a position of the movable member by detecting a displacement of the movable member using a sensor and a scale that face each other, the plurality of scales including two first scales configured to detect displacements of the movable member in a first direction, and two second scales configured to detect displacements of the movable member in a second direction different from the first direction, and the apparatus comprising a controller configured to reduce a measurement error resulting from a geometrical error between the two first scales.

### BACKGROUND OF THE INVENTION

1. Field of the Invention

The present invention relates to a measurement apparatus, an exposure apparatus, and a device manufacturing method.

2. Description of the Related Art

An exposure apparatus is employed in a lithography process. The exposure apparatus projects a circuit pattern drawn on a reticle (original) onto a substrate by a projection optical system to expose the substrate. The substrate is held by a substrate chuck mounted on a stage. The stage is positioned while its position is measured by a laser interferometer. Since a laser interferometer has an advantage in that it has a high resolution and a degree of freedom of placement higher than other measurement devices, it is widely used in an exposure apparatus. On the other hand, a laser interferometer often generates a measurement error in response to a change in environment of the optical path of laser light. Hence, a technique to suppress the change in environment of the optical path or correcting the measurement error is required. Examples of the change in environment of the optical path are changes in temperature, humidity, and pressure (atmospheric pressure or sound pressure). As the required precision increases, a change in air composition may also become an error factor. To perform measurement with a precision as high as 1 nm or less by a laser interferometer in an exposure apparatus, it is necessary to control its environment with a precision corresponding to at least a temperature of 1/1,000° C., a humidity of 0.1%, and a pressure of 1 Pa, or to correct the measurement result in real time by a certain method.

Since such environmental control and measurement result correction have practical limits, an exposure apparatus that measures the position of a stage using an encoder system has recently been developed. Japanese Patent Laid-Open Nos. 2007-129194 and 2007-266581 each disclose a measurement system in which four scales are arranged around a projection optical system as position measurement references, and four sensors are arranged on a stage. This measurement system can measure the position of the stage with high precision using three appropriate scales and three appropriate sensors selected in accordance with the position of the stage.

When the stage is positioned using the encoder system, a stage positioning error may occur as the positional relationship among the scales serving as measurement references change due to, for example, their thermal deformation.

### SUMMARY OF THE INVENTION

The present invention provides a technique advantageous to reduce a measurement error resulting from a geometrical error between scales.

One of the aspects of the present invention provides a measurement apparatus which includes a plurality of sensors arranged on a movable member, and a plurality of scales attached to a structure, and measures a position of the movable member by detecting a displacement of the movable member using a sensor and a scale that face each other, the plurality of scales including two first scales configured to detect displacements of the movable member in a first direction, and two second scales configured to detect displacements of the movable member in a second direction different from the first direction, and the apparatus comprising a controller configured to reduce a measurement error resulting from a geometrical error between the two first scales based on a difference between displacements detected by two sensors, respectively, facing the two first scales when the movable member moves from a first position to a second position so that values detected by two sensors facing the two second scales when the movable member is at the first position become equal to values detected by the two sensors facing the two second scales when the movable member is at the second position.

Further features of the present invention will become apparent from the following description of exemplary embodiments with reference to the attached drawings.

### BRIEF DESCRIPTION OF THE DRAWINGS

FIG. 1 is a view that describes the schematic arrangement of an exposure apparatus according to one embodiment of the present invention;

FIG. 2 is a view that describes the relationship among scales, sensors, and a stage in the first to fourth embodiments;

FIGS. 3A to 3E are views that describe the relationships between respective stage positions and usable sensors in the first to fourth embodiments;

FIGS. 4A and 4B are views illustrating examples of a scale change to be corrected in the first to fourth embodiments;

FIGS. 5A to 5G are views for explaining a phenomenon called “a positional shift of the stage”;

FIG. 6 is a view that describes the definition of a scale change, which is adopted in the first to fourth embodiments;

FIG. 7 is a flowchart that describes a correction method;

FIG. 8 is a view that describes measurement points and scale changes to be corrected in the first embodiment;

FIG. 9 is a view that describes measurement points and scale changes to be corrected in the second embodiment;

FIG. 10 is a view that describes measurement points and scale changes to be corrected in the third embodiment;

FIG. 11 is a view that describes measurement points and scale changes to be corrected in the fifth embodiment;

FIG. 12 is a view that describes measurement points and scale changes to be corrected in the sixth embodiment; and

FIG. 13 is a flowchart that describes a correction method according to the sixth embodiment.

### DESCRIPTION OF THE EMBODIMENTS

Embodiments of the present invention will be described below with reference to the accompanying drawings.

### First Embodiment

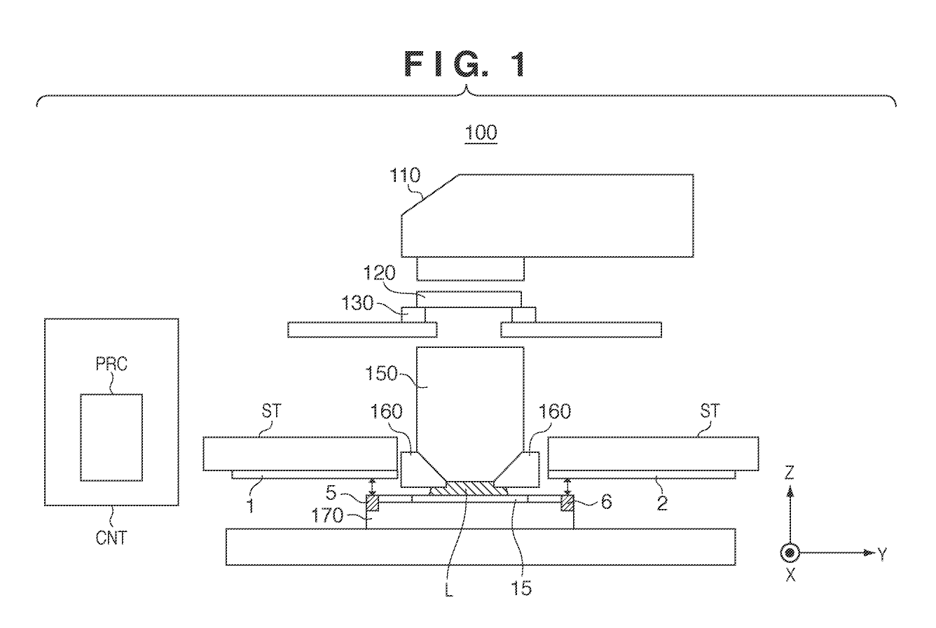

An exposure apparatus 100 according to the first embodiment will be described below with reference to FIGS. 1 to 3A to 3E. The exposure apparatus 100 projects the pattern of a reticle (original) 120 illuminated by an illumination optical system 110 onto a wafer (substrate) 15 by a projection optical system 150 to expose the wafer 15. The exposure apparatus 100 can be configured to, for example, expose the wafer 15 while synchronously scanning a wafer stage (substrate stage) 170 that holds the wafer 15, and a reticle stage (original stage) 130 which holds the reticle 120. The exposure apparatus 100 may also be designed as an immersion exposure apparatus. In this case, the exposure apparatus 100 can be provided with a liquid film holding mechanism 160 in order to hold a liquid L below the final lens of the projection optical system 150.

A measurement apparatus MD which measures the position of the wafer stage 170 as a movable member to be measured includes a plurality of sensors (encoders) 5 to 8 arranged on the wafer stage 170, and a plurality of scales 1 to 4 attached to a structure ST. The structure ST can be, for example, integrated with a support member, which supports the projection optical system 150, or fixed on the support member.

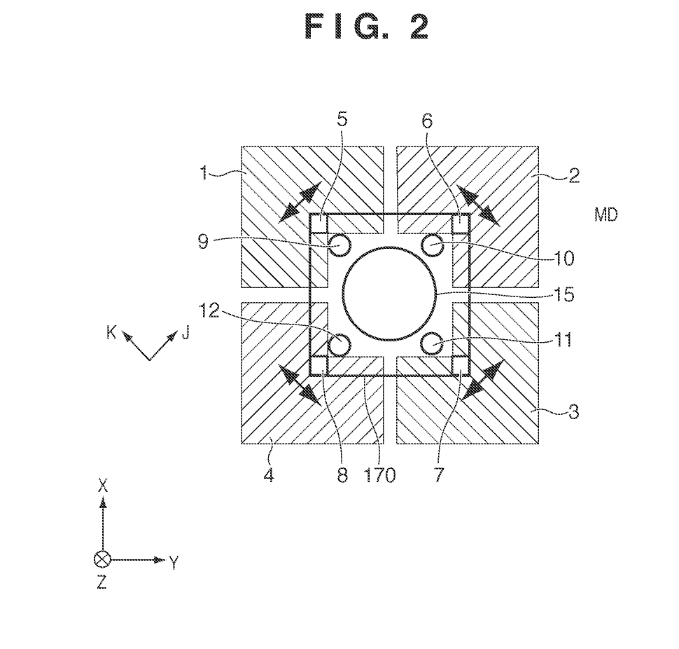

FIG. 2 is a schematic view that describes the scales 1 to 4 and the sensors 5 to 8, mounted on the wafer stage 170, when viewed from below. Note that for the sake of convenience, the wafer stage 170 is drawn as a see-through object in FIG. 2. The scales 1 to 4 are nearly flat plates, and are attached to the structure ST so as to surround the projection optical system 150. As illustrated in FIG. 2, a plurality of grooves are formed in each of the scales 2 and 4 at a predetermined array pitch to be parallel to the J-axis obtained by rotating the X-axis direction through +45°. A plurality of grooves are formed in each of the scales 1 and 3 at a predetermined array pitch to be parallel to the K-axis obtained by rotating the Y-axis direction through +45°. These grooves function as diffraction gratings (gratings). The sensors 5 to 8 irradiate the diffraction gratings in the scales 1 to 4 facing them, respectively, with light beams to detect interference fringes formed by the diffracted light beams reflected by the diffraction gratings.

As the wafer stage 170 moves, the interference fringes move relative to the sensors 5 to 8. The sensors 5 to 8 detect displacements of the wafer stage 170 based on the relative movement of the interference fringes. When, for example, the sensor 5 faces the scale 1, it can detect a displacement of the wafer stage 170 in the J-axis direction. Also, when the sensor 6 faces the scale 2, it can detect a displacement of the wafer stage 170 in the K-axis direction. Similarly, a combination of the scale 3 and the sensor 7 can detect a displacement of the wafer stage 170 in the J-axis direction, and a combination of the scale 4 and the sensor 8 can detect a displacement of the wafer stage 170 in the K-axis direction. Hence, displacements on the X- and Y-axes (or the K- and J-axes) and the axis of rotation Rz about the Z-axis can be measured using three sets of scales and sensors facing each other. Also, at least one reference mark (reference marks 9 to 12 in this case) is placed on the wafer stage 170, and used to align the wafer 15 and the reticle 120.

In this embodiment, the plurality of scales 1 to 4 include first scales (for example, the scales 2 and 4) and second scales (for example, the scales 1 and 3). The first scales (for example, the scales 2 and 4) are used to detect displacements of the stage 170 in a first direction (for example, the K-axis direction). The second scales (for example, the scales 1 and 3) are used to detect displacements of the stage 170 in a second direction (for example, the J-axis direction) different from the first direction. The positional relationship between the first scales and the second scales in this embodiment can be described as follows. That is, a first line parallel to the first direction (for example, the K-axis direction), and a second line parallel to the second direction (for example, the J-axis direction), intersect at right angles at a given point. Also, two first scales (for example, the scales 2 and 4) are arranged to sandwich the given point between them on the second line, and two second scales (for example, the scales 1 and 3) are arranged to sandwich the given point between them on the first line.

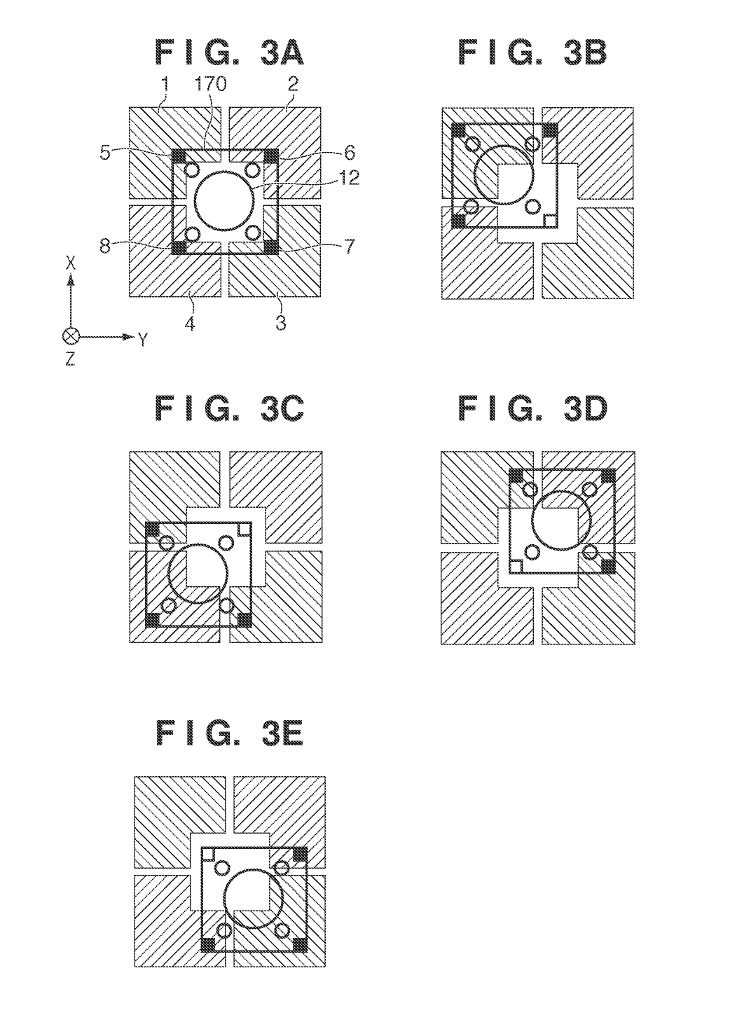

FIGS. 3A to 3E are schematic views that describes the stage 170, the scales 1 to 4, and the sensors 5 to 8 when viewed from below. Note that for the sake of convenience, the wafer stage 170 is drawn as see-through objects in FIGS. 3A to 3E. FIGS. 3A to 3E illustrate the positional relationships between the stage 170 and the scales 1 to 4, and sensors, which can be used to detect displacements of the stage 170, among the sensors 5 to 8. Reference numerals are not shown in FIGS. 3B, 3C, 3D, and 3E. Referring to FIGS. 3A to 3E, each sensor indicated by a filled square faces one of the scales 1 to 4, and can be used to detect a displacement of the stage 170. Each sensor indicated by an open square faces none of the scales 1 to 4, and cannot be used to detect a displacement of the stage 170.

In a state shown in FIG. 3A, all of the four sensors 5 to 8 face the corresponding scales 1 to 4, respectively, and can be used to detect displacements of the stage 170. In a state shown in FIG. 3B, the sensors 5, 6, and 8 can be used to detect displacements of the stage 170, but the sensor 7 cannot be used for this detection. In this manner, whether the sensors 5 to 8 can be used to detect displacements of the stage 170 changes depending on the position of the stage 170. Note that at least three sensors among the sensors 5 to 8 are used to detect the position of the stage 170, irrespective of the position of the stage 170.

In this embodiment, the movable area of the stage 170 includes a first region and second region. The first region mentioned herein is a region where one of two first scales faces a sensor, but the other one of the first scales faces no sensor. The second region is a region where the former first scale faces no sensor, but the latter first scale faces a sensor. A first scale, used to detect a displacement of the stage 170, of the two first scales is changed when the stage 170 moves from the first region to the second region and from the second region to the first region.

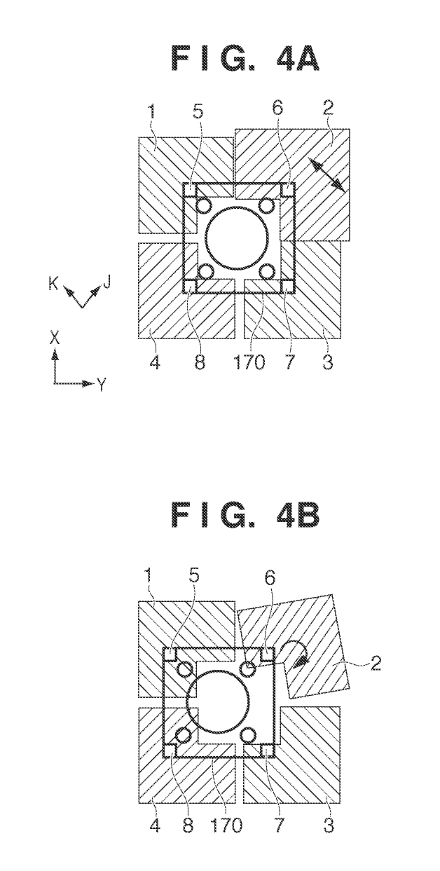

The measurement apparatus MD as described above may generate a measurement error in response to a change in positional relationship among the scales 1 to 4 or in scale magnification. As an example, as shown in FIG. 4A, the array pitch (scale magnification) of the diffraction grating in the scale 2 may become larger than those of the diffraction gratings in the other scales 1, 3, and 4 as the scale 2 expands due to, for example, thermal deformation with time. As another example, the scale 2 may rotate about the Z-axis from the initial state, as shown in FIG. 4B, as deformation of the structure ST occurs with time. As still another example, a certain scale may simply translate on the X-Y plane. These phenomena may occur due to manufacturing errors or attachment errors as well. Although cases in which only the scale 2 has changed are shown in FIGS. 4A and 4B, all or some of the scales 1 to 4 may suffer similar changes.

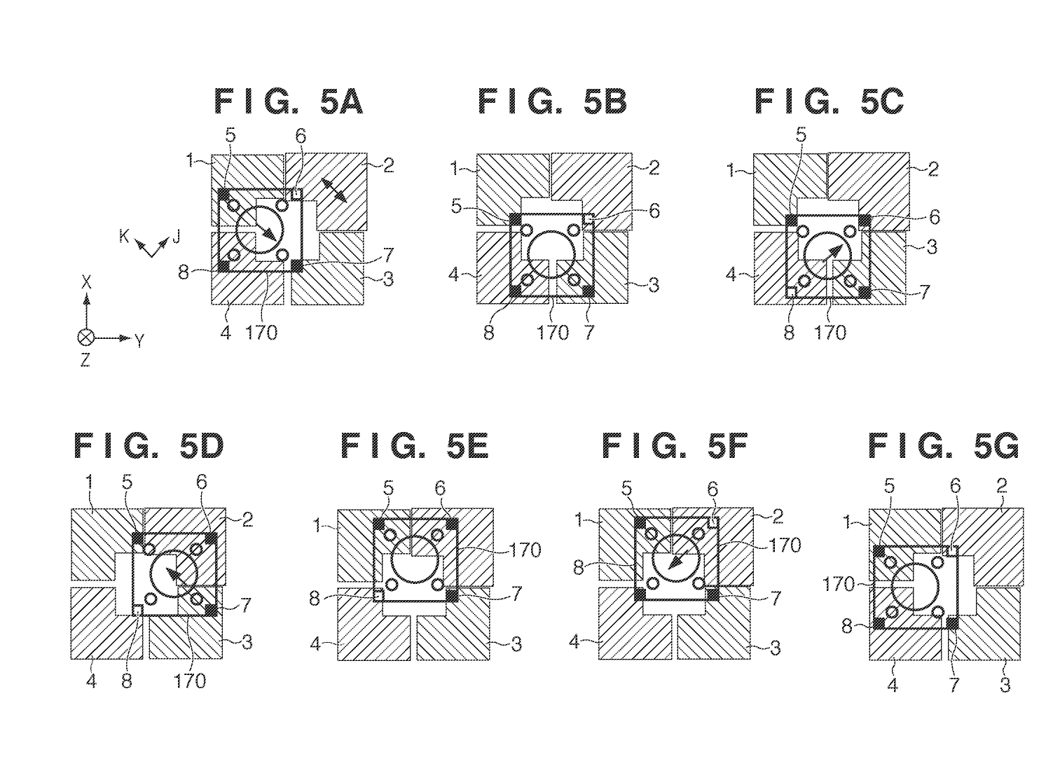

The reason why a measurement error occurs when the magnification (array pitch) of a certain scale has changed, as shown in FIG. 4A, will be given as an example with reference to FIGS. 5A and 5B. FIG. 5A shows the initial state, in which only the scale 2 expands in the K direction, as indicated by an arrow. In the state shown in FIG. 5A, a displacement (position) of the stage 170 in the K-axis direction is detected (measured) by the scale 4 and sensor 8, and that in the J-axis direction is detected (measured) by the scale 3 and sensor 7. A displacement of the stage 170 in the J-axis direction is detected (measured) by the scale 1 and sensor 5 as well. The rotation Rz of the stage 170 about the Z-axis can also be obtained based on the two detection results in the J-axis direction. In the state shown in FIG. 5A, the scale 2 and sensor 6 are not used to detect (measure) a displacement (position) of the stage 170.

A case in which the stage 170 moves in a direction (−K-axis direction) indicated by an arrow from the state shown in FIG. 5A and enters a state shown in FIG. 5B will be considered. In this case, assume that the difference between displacements (changes in position) of the stage 170 detected by the sensors 5 and 7, respectively, is zero, and a displacement (a change in position) of the stage 170 detected by the sensor 8 is “10”. For the sake of a better understanding, the value “10” can be interpreted as, for example, 10 diffraction grating lines (parallel grooves) the sensor 8 crosses. Also, setting the difference between displacements of the stage 170, which are detected by the sensors 5 and 7, respectively, to zero amounts to not changing the rotation Rz of the stage 170 about the Z-axis.

Assume herein that the array pitches of the diffraction gratings in the scales 1, 3, and 4 are p1, and only the scale 2 thermally expands to have a larger scale magnification so that its array pitch becomes p2. At this time, when a shift from the state shown in FIG. 5A to that shown in FIG. 5B is made, the physical moving distance of the stage 170 can be 10×p1. In this state, the value “10” as the displacement value detected by the sensor 8 is taken over, and the sensor used is switched from the sensor 8 to the sensor 6 to make a shift to a state shown in FIG. 5C. The stage 170 then moves by “10” in the +J-axis direction. At this time, the displacement value detected by the sensor 6 is kept “0”, and the difference between the displacement values detected by the sensors 5 and 7 are set to “0”. This amounts to setting the rotation Rz of the stage 170 about the Z-axis to “0”. Although the sensor 8 deviates from the position, where it faces the scale 4, on its way at that time, the displacement value detected by the sensor 8 is taken over from the sensor 8 to the sensor 6, so the measurement is not interrupted. After that, a shift to a state shown in FIG. 5D is made. A shift from this state to a state shown in FIG. 5E is made by moving the stage 170 so that the displacement value detected by the sensor 6 changes from “10” to “0” without changing the difference between the displacement values detected by the sensors 5 and 7. Note that since the array pitch of the diffraction grating in the scale 2 is p2, the stage 170 has physically moved by an amount of 10×p2.

A shift to a state shown in FIG. 5F is then made. In this state, a displacement of the stage 170 is detected using the scale 4 upon taking over the value “0” detected using the scale 2. When the stage 170 further moves by “−10” in the J direction, a shift to a state shown in FIG. 5G is made.

In this manner, when the stage 170 moves as shown in FIGS. 5A to 5G, it returns to the initial position upon circling once. However, in practice, the stage 170 physically returns to a position spaced apart from the initial position in the K-axis direction by 10×(p2−p1) because the diffraction grating in the scale 2 has an array pitch different from those in the other scales. Such a phenomenon will be referred to as “a positional shift of the stage” hereinafter. A measurement error may gradually increase as “the positional shift of the stage” accumulates. For example, when a series of movement of the stage 170, shown in FIGS. 5A to 5G, is repeated N times, “the positional shift of the stage” occurs by a physical distance of N×10×(p2−p1) upon simple accumulation. An error which accumulates upon the movement of the stage 170 in this way is desirably corrected.

“The positional shift of the stage” may occur due to the difference in attitude in the rotational direction (rotation angle (the rotation Rz about the Z-axis)) of the scale, as shown in FIG. 4B, as well as a change in scale magnification as shown in FIG. 4A. Normally, each of these scales may independently generate a change in scale magnification or scale rotation.

In this embodiment, a processor PRC is provided. The processor PRC corrects a measurement error resulting from a geometrical error such as the differences between the array pitches of the diffraction gratings in the scales or the differences between the scale attitudes (rotation angles). The processor PRC constitutes a part of the measurement apparatus MD and can be built in, for example, a controller CNT which controls the exposure operation of the exposure apparatus. The controller CNT moves the stage 170 while continuously detecting displacements of the stage 170 using two sensors (for example, the sensors 6 and 8) facing two first scales (for example, the scales 2 and 4), respectively. The processor PRC performs an arithmetic operation for reducing a measurement error resulting from a geometrical error between the two first scales (for example, the scales 2 and 4), based on the difference between displacements detected by the two sensors (for example, the sensors 6 and 8) facing the two first scales, respectively, at that time.

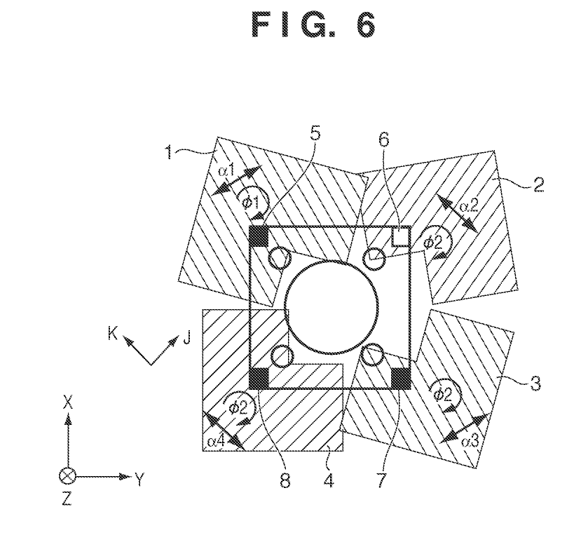

Several variables will be defined herein. Referring to FIG. 6, the magnification of the array pitch of the diffraction grating in each of the scales 1 to 4 is defined as α. More specifically, the magnification of the array pitch of the diffraction grating in a reference state is defined as α. Also, the scale rotation angle from a reference state is defined as φ. Although the reference state can be, for example, an ideal array pitch or rotation angle assumed in designing, it is not limited to these examples, and may be, for example, the state in which scale correction and measurement have been performed for the last time. Suffixes attached to α and φ correspond to the scales 1 to 4. In other words, α1 and φ1 indicate the magnification of the array pitch of the scale 1, and the rotation angle of the scale 1, respectively.

The scales 1 and 3 serve to detect (measure) displacements (positions) of the stage 170 in the J-axis direction, and the scales 2 and 4 serve to detect (measure) displacements (positions) of the stage 170 in the K-axis direction.

For the sake of convenience in describing a measurement error using equations, αK, αj, φK, and φJ are defined as:

αJ=α1/α3 (1)

αK=α2/α4 (2)

φJ=φ1−φ3 (3)

φK=φ2−φ4 (4)

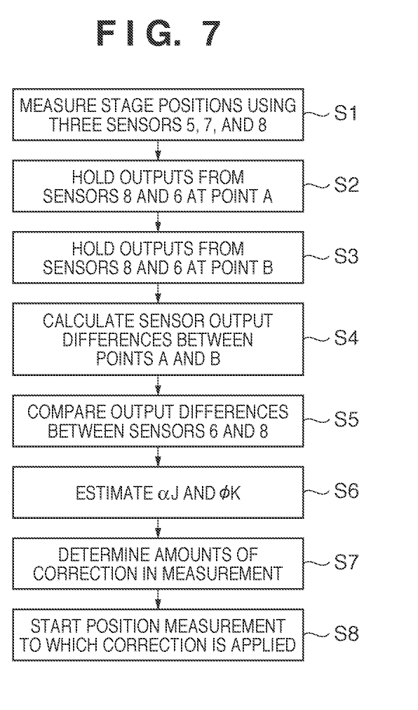

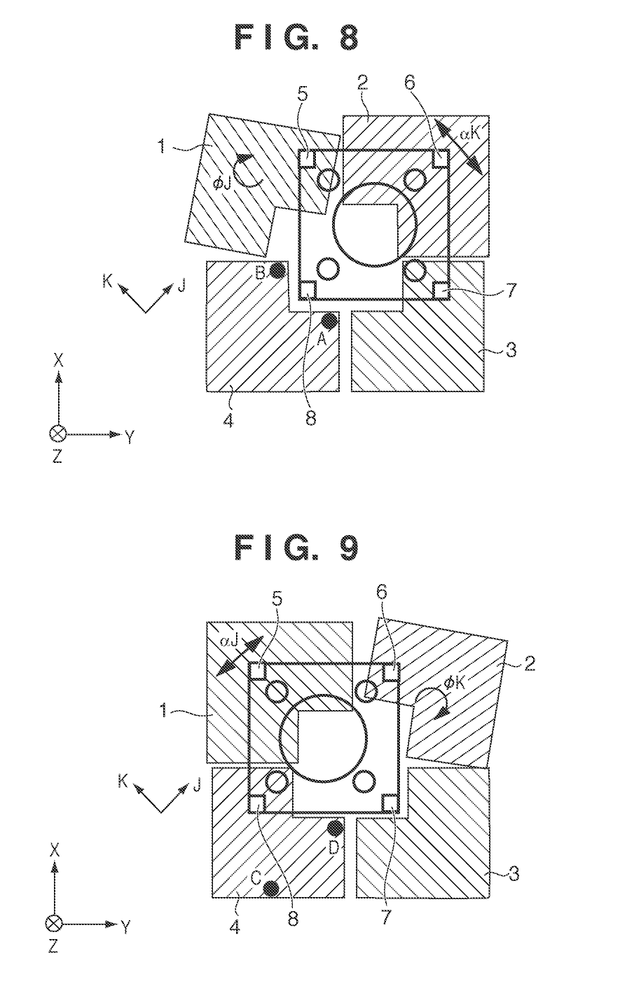

A correction method for reducing a measurement error due to “a positional shift of the stage” will be described next with reference to FIGS. 7 and 8. FIG. 8 illustrates an example in which the magnification ratio of the scale 2 to the scale 4 is αK, and the rotation angle difference of the scale 1 relative to the scale 3 is φJ.

First, in step S1, under the control of the controller CNT, the positions of the stage 170 in three axial directions are measured using the three sensors 5, 7, and 8, respectively. As a detailed example, the position of the stage 170 in the K-axis direction is measured using the sensor 8, and the position of the stage 170 in the J-axis direction is measured using the sensor 7. Moreover, the rotation Rz of the stage 170 about the Z-axis is measured using the difference between the values detected by the sensors 5 and 7.

Next, in step S2, under the control of the controller CNT, the stage 170 is driven to a first position, where the sensor 8 faces a measurement point A on the scale 4, while maintaining the state in which measurement can be performed using the sensors 5, 7, and 8. Also, the values detected by the sensors 8 and 6 at the first position are stored in a memory. The memory can be provided to, for example, the processor PRC.

In step S3, under the control of the controller CNT, the stage 170 is driven to a second position where the sensor 8 faces a measurement point B on the scale 4. Also, the values detected by the sensors 8 and 6 at the second position are stored in the memory. Note that the stage 170 moves from the first position to the second position upon being driven along the moving path in which all of the four sensors 5 to 8 can continuously detect displacements. At this time, the controller CNT controls so that the values detected by the sensors 5 and 7 facing the second scales 1 and 3, respectively, when the stage 170 is at the first position are equal to those detected by the sensors 5 and 7 facing the second scales 1 and 3, respectively, when the stage 170 is at the second position. This means that the attitude (rotation angle; Rz) of the stage 170 at the first position is equal to that of the stage 170 at the second position. However, it is often the case that the values detected by the sensors 5 and 7 facing the second scales 1 and 3, respectively, when the stage 170 is at the first position are not equal to those detected by the sensors 5 and 7 facing the second scales 1 and 3, respectively, when the stage 170 is at the second position. In this case, rotational components of the stage 170 must be taken into consideration in the following steps.

In step S4, the processor PRC calculates the difference (output difference) between the values which are detected by the sensor 8 and stored in steps S2 and S3, that is, a distance a1 between the measurement points A and B in the K-axis direction, which is detected by the sensor 8. The processor PRC also calculates the difference (output difference) between the values which are detected by the sensor 6 and stored in the memory in steps S2 and S3, that is, a distance a1′ between the measurement points A and B in the K-axis direction, which is detected by the sensor 6.

In step S5, the processor PRC compares the distance a1′ measured using the sensor 6, and the distance a1 measured using the sensor 8. Although a method of comparison is not limited to a specific one, the difference between the two distances: b1=a1′−a1 is calculated as a simple method. If the scales 1 to 4 have no geometrical errors, that is, they hold an ideal positional relationship free from any changes in shape, the two distances a1 and a1′ naturally have the same values, so the difference b1 is zero. In contrast, if the scales 1 to 4 have geometrical errors which fall outside a tolerance, the difference b1 neither is zero nor falls within a tolerance. Hence, the processor PRC may perform processes subsequent to step S5 if the difference b1 falls outside a tolerance, and cancel these processes otherwise.

In step S6, the processor PRC estimates the scale rotation angle difference (φJ or φK) and the scale pitch magnification ratio (αJ or αK) based on the difference b1. In an example illustrated in FIG. 8, the values αK and φJ can be estimated. However, the values αJ and φK can also be estimated depending on the positions of measurement points.

In step S7, the processor PRC determines the amounts of correction in measuring the position of the stage 170, based on the estimated values. In step S8, the position of the stage 170 is measured while the values detected by the sensors are corrected in accordance with the amounts of correction by the processor PRC.

A method of estimating the values αK and φJ will be described in detail below. Referring to FIG. 8, the measurement points A and B on the scale 2 are selected to meet the following conditions.

<Condition 1>

During the period in which the stage 170 moves from the first position where a sensor faces the measurement point A to the second position where the sensor faces the measurement point B, or from the second position to the first position, the four sensors 5 to 8 face the scales 1 to 4, respectively, and the outputs from the sensors 5 to 8 can therefore be continuously obtained.

<Condition 2>

The measurement points A and B are set on a line parallel to the array direction (K-axis direction) of the diffraction grating in the scale 2.

The larger the distance between the measurement points A and B, the higher the obtained correction accuracy becomes. When the measurement points A and B are determined to meet conditions 1 and 2, the distance between the measurement points A and B in the K-axis direction, which is measured using the sensor 6, is defined as a1′, and the distance between the measurement points A and B in the K-axis direction, which is measured using the sensor 8, is defined as a1.

Assuming that the stage 170 has a square shape, the relationship between a1′ and a1 when the scales have a magnification ratio and a rotation angle difference, as shown in FIG. 8, is geometrically described by:

a1′=a1/αK−1/√2×a1×tan(φJ)/αK (5)

Also, assuming that φJ is sufficiently small, tan(φJ) is approximately equal to φJ and we have:

a1′=a1/αK×(1−1/√2×φJ) (6)

Moreover, the difference b1 between the distances measured by the sensors 6 and 8 is given by:

b1=a1′−a1=a1/αK×(1−1/√2×φJ−αK) (7)

First, assuming the sensor 8 and scale 4 as references, the scale 2 has a size αK a times that of the scale 4, so the distance (displacement) measured by the sensor 6 is 1/αK times that measured by the sensor 8. This is expressed by the first term on the right-hand side of equation (5). Also, when the scale 1 has a rotation angle difference φJ relative to the scale 3, the rotation Rz of the stage 170 about the Z-axis is measured using each of the scales 1 and 3, so the attitude of the stage 170 in the Rz direction changes as the stage 170 moves in the K-axis direction. More specifically, the stage 170 moves between the first position corresponding to the measurement point A and the second position corresponding to the measurement point B while maintaining its attitude so as not to change the outputs from the sensors 5 and 7 (so as not to change the attitude of the stage 170 in the Rz direction). At this time, when the scale 1 has the rotation angle difference φJ, the stage 170 rotates in the Rz direction about the sensor 7 as a center while moving between the first position and the second position. Upon the rotation of the stage 170 in the Rz direction, a difference may occur between the distances in the K-axis direction measured by the sensors 6 and 8. Under normal circumstances, the sensor 5 must move by a1 in the K-axis direction on the scale 1, and by zero in the J-axis direction on the scale 1. However, as the scale 1 has the rotation angle difference φJ, the sensor 5 not only moves by a1 in the K-axis direction but also moves by a1×tan (φJ) in the J-axis direction while the sensor 8 moves between the measurement points A and B. Then, when the stage 170 has a square shape, the sensor 6 moves by −1/√2×a1×tan(φJ) in the K-axis direction due to the influence of the rotation of the stage 170 about the sensor 7 as a rotation center. Again, when the stage 170 has a square shape, the distance between the sensors 7 and 6 is 1/√2 assuming the distance between the sensors 7 and 5 as 1. Thus, upon the rotation of the stage 170 about the sensor 7 as a center, the amount of movement of the sensor 6 in the J-axis direction is 1/√2 times that of the sensor 5 in the J-axis direction. Also, as described earlier, as the distance measured using the sensor 6 is 1/αK times that measured using the sensor 8, the former distance has a difference of −1/√2×a1×tan(φj)/αK relative to the latter distance. This is expressed by the second term on the right-hand side of equation (5). Note that in a reference state which does not require correction at all, αK=1 and φJ=0. In this case, equations (5) and (6) naturally satisfy a1′=a1, and therefore b1=0 in equation (7).

From this relationship, αK and φJ are estimated. Nevertheless, two variables: αK and φJ cannot be determined using only equation (7) even if the distances a1 and b1 are known. Hence, these variables are estimated using a certain assumption.

If, for example, the scales 1 to 4 are fixed on a single structure ST, they may suffer thermal deformation in amounts different from each other due to the influence of the temperature distribution of the structure ST. In such a case, a change may occur in magnification ratio αK or αJ. Nevertheless, unless warpage occurs in the structure ST, no changes are expected to occur in rotation angle among the scales 1 to 4, so the rotation angle difference φJ or φK may be very small, if any. Hence, assuming that actual rotation differences φJ and φK are negligible, in equation (7), an estimated value φJ′ of φJ is zero, and an estimated value αK′ of αK is given by:

αK′=a1/(a1+b1) (8)

Such an assumption is desirably determined based on a plurality of evaluation results. An assumption can be determined based on, for example, the evaluation results of weighting the amounts of change in two variables. Assume that it is only necessary to correct “the positional shift of the stage” even only slightly. In this case, estimated values αK′ and φJ′ which satisfy equation (7) need only be determined, so these estimated values may be different from true values. However, in practice, despite suppression of “the positional shift of the stage”, the differences between estimated values and true values may lead to a measurement error generated by the measurement apparatus MD. In view of this, the required precision of estimated values is desirably determined after the degree of influence of the differences between the estimated values and true values is evaluated. The present invention is not limited to the above-mentioned estimation method, and an estimation method can be flexibly determined in accordance with the required precision.

A method of determining the amounts of correction in measurement from the estimated scale pitch magnification ratio αK and scale rotation angle difference φJ will be described in detail next. According to equation (8), from equation (1), the magnification α2 of the array pitch in the scale 2 is a1/(a1+b1) times the magnification α4 of the array pitch in the scale 4. In other words, the distance measured by the sensor 6 is estimated to be a1/(a1+b1) times that measured by the sensor 8. Hence, the processor PRC can perform correction so that a value obtained by multiplying the distance measured using the sensor 6 by the reciprocal of the estimated magnification ratio, that is, by (a1+b1)/a1 is determined as the value measured using the sensor 6. In many cases, a general encoder system sets an origin as a reference, and outputs the distance from the origin as a measured value. In this case, upon measurement using the scale 2, a value obtained by simply multiplying the value (raw data) output from the sensor 6 corresponding to the distance (displacement) from the origin by the reciprocal of an estimated value (1/αK) may be processed as the distance measured using the sensor 6.

A correction method which reflects the estimated value φJ is more complex. Correction can be generally performed by multiplying the value (raw data) output from the sensor 6 by a coordinate transformation matrix including a rotation matrix. In other words, the same effect as that obtained by physically rotating the scale 1 by −φJ′ can be obtained by generating a coordinate transformation matrix based on the estimated value φj′ of the rotation angle difference, and multiplying the value output from the sensor 6 by the generated matrix.

In this embodiment, an algorithmic process is performed so as to obtain the same effect as that obtained by an operation of physically deforming the scale 2 to have the same magnification as the scale 4, and physically matching the rotation angle of the scale 1 with that of the scale 3, based on the estimated values αK and φK. However, as a matter of course, a driving unit which can physically deform or rotate a scale may be provided to drive the scale based on the estimated values αK and φJ.

Lastly, the position and attitude (rotation angle) of the stage 170 can be determined using the measured values corrected in the foregoing way. When such correction is adopted, the sensors 6 and 8 output the same distance between the measurement points A and B in the K-axis direction, and inconsistency of displacement measurement among the scales can thus be eliminated. In other words, “a positional shift of the stage” as described with reference to FIGS. 5A to 5G is eliminated.

As described earlier, the correction method exemplified herein merely estimates αK and φJ under a certain assumption such that equation (7) holds, and they are not perfectly identified. Thus, although “a positional shift of the stage” is eliminated, the differences between estimated values and true values may influence the rotational attitude Rz of the stage, and, in turn, influence the exposure accuracy when that method is applied to an exposure apparatus. As a matter of course, correction can be preferably performed after estimated values close to true values are obtained. Nevertheless, the reason why correction for eliminating “a positional shift of the stage” is performed at the risk of adversely affecting the rotation Rz of the stage 170 is as follows. In other words, “the positional shift of the stage” may accumulate an error every time the scale is switched, and this may cause a fatal systematic failure. Even for processing of only one wafer, the scales 1 to 4 and sensors 5 to 8 may be switched at least 10 times when the movement of the stage 170 in the exposure apparatus is taken into consideration. For example, even an error as small as 0.1 nm per scale switching operation may accumulate into a measurement error of 1 nm upon scale switching 10 times, and this is likely to pose a serious problem in the measurement apparatus MD. In contrast, an error which does not accumulate needs less correction. Hence, correction to suppress “the positional shift of the stage” has a priority level much higher than prevention of deterioration, in precision of the rotation Rz of the stage 170, in which no error accumulates. If the rotation Rz of the stage 170 has deteriorated in precision to a problematic level, it must undergo another correction, as a matter of course.

According to this embodiment, an accumulated error which may pose a serious problem in measurement can be suppressed without providing a new measurement device or a measurement target such as a reference wafer. Moreover, it advantageously takes a very short time for correction because the distance between two set points need only be measured.

Although a method of correction using measurement points on the scale 4 has been described in this embodiment, similar correction can be performed by setting similar measurement points on the other scales (the scales 1, 2, and 3).

### Second Embodiment

The second embodiment of the present invention will be described with reference to FIG. 9. In an example illustrated in FIG. 8, measurement points A and B on a scale 4 are set on a line parallel to the array direction (K-axis) of the diffraction grating in the scale 4. In an example illustrated in FIG. 9, measurement points C and D on a scale 4 are set on a line parallel to a direction (J-axis) perpendicular to the array direction of the diffraction grating in the scale 4. Also, a stage 170 is driven from a position corresponding to the measurement point C to that corresponding to the measurement point D while displacements of the stage 170 are continuously detected by four sensors 5 to 8.

In the second embodiment, correction is performed in a measurement apparatus MD basically in accordance with the flowchart shown in FIG. 7, as in the first embodiment. However, the measurement points A and B correspond to the measurement points C and D, respectively, and αJ and φK correspond to αK and φj, respectively. For the sake of supplement to step S5, this correction will be described in detail in association with FIG. 9.

When two measurement points such as the measurement points C and D are selected, the influence of φK and αJ, in turn, influences detection of displacements in the K-axis direction between the measurement points C and D. The distance between the measurement points C and D in the J-axis direction, which is detected by the sensor 7, when the stage 170 moves so that the sensor 8 moves between the measurement points C and D is defined as d2, and the distance between the measurement points C and D in the K-axis direction, which is detected by the sensor 8, at this time is defined as a2′. Because the measurement points C and D are set parallel to the J-axis direction, the distance a2 in the K-axis direction, which is detected by the sensor 8, is zero as:

a2=0 (9)

Also, the distance a2′ in the K-axis direction, which is detected by the sensor 6, is given by:

a2′=d2×sin(φK)−d2×(αJ−1) (10)

Assuming that φK is sufficiently small, sin(φK)=φK approximately holds and we have from equation (9):

b2=a2′−a2=d2×(φK−αJ+1) (11)

If the scales have an ideal positional relationship conforming to their designs, b2=0 from φK=0 and αJ=1. In this case, the sensors have no output differences among them, so “the positional shift of the stage” does not occur. Also, when b2≠0, estimated values φK′ and αJ′ are calculated based on equation (11) under an assumption as described in the first embodiment. In other words, the estimated values φK′ and αJ′ of φK and αJ, respectively, satisfy:

φK′−αJ′+1=b2 (12)

Note that b2 is known by measurement. Assuming that a change in φK is less likely to occur, as described in the first embodiment,

φK′=0 (13)

approximately holds. This yields:

αJ′=1−b2 (14)

When the estimated values αJ′ and φK′ are obtained, correction can be performed by generating a coordinate transformation matrix based on the estimated values, and multiplying the value (raw data) output from the sensor 6 by the generated matrix, as in the first embodiment. In other words, a coordinate transformation matrix including a rotation matrix is generated based on the estimated value φJ′ of the rotation angle difference, and the value output from the sensor 6 is multiplied by the generated matrix. This makes it possible to obtain the same effect as that obtained by matching the magnifications of the scales 3 and 1 by physically rotating the scale 1 by −φK′ or deforming the scale 1 by αJ′−1.

By correcting the value, output from a sensor, using a processor PRC in the foregoing way, “a positional shift of the stage” encountered when the stage 170 moves in the J-axis direction is eliminated. Also, when the first and second embodiments are practiced in combination, “a positional shift of the stage” encountered when the stage 170 moves in both the K- and J-axis directions, that is, over the entire plane defined by the K- and J-axes is eliminated. In this case, since the measurement point A in the first embodiment corresponds to the measurement point C in the second embodiment, measurement need only be performed at a total of three points.

Also, similar correction can be performed using points defined on a plurality of scales instead of using points defined on only one scale. For example, it is also possible to correct “the positional shift of the stage” in the K-axis direction using points defined on a scale 2, and correct “the positional shift of the stage” in the J-axis direction using points defined on a scale 1.

### Third Embodiment

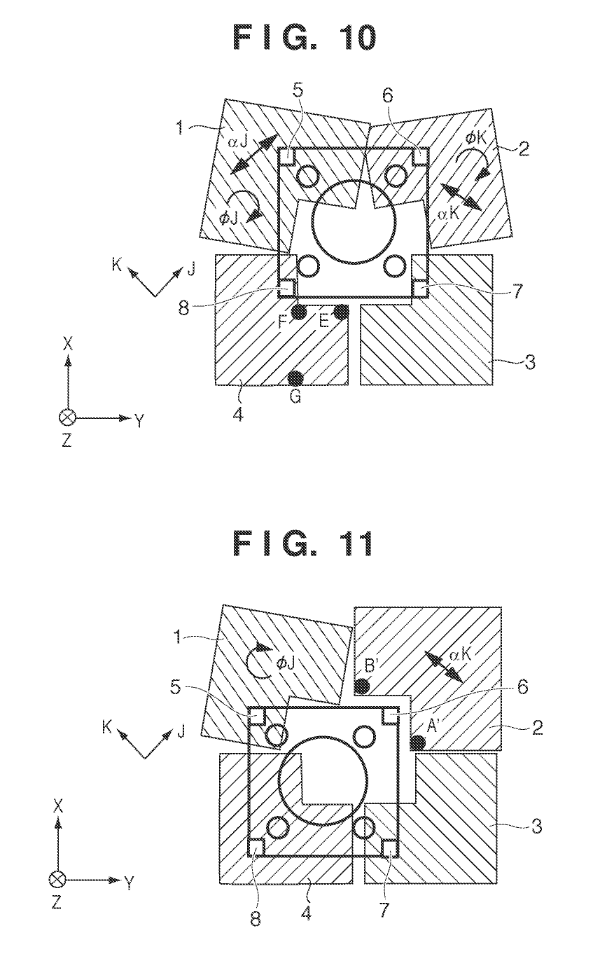

In the first and second embodiments, measurement points are defined on a line parallel to the diffraction grating direction (K-axis) or a direction (J-axis) perpendicular to it. In the third embodiment, an example in which measurement is performed at three measurement points that are not set on the same line will be explained with reference to FIG. 10.

A stage 170 is driven to move among three positions corresponding to measurement points E, F, and G, respectively, while displacements of the stage 170 are continuously detected by four sensors 5 to 8.

The third embodiment is a simple combination of the first and second embodiments. When the distance between the measurement points E and F in the K-axis direction is defined as a3, and that in the J-axis direction is defined as d3, a difference b3 between the outputs from the sensors 6 and 8 is given by:

b3=a3/αK×(1−1/√2×φJ−αK)+d3×(φK−αJ+1) (15)

Similarly, when the distance between the measurement points F and G in the K-axis direction is defined as a4, and that in the J-axis direction is defined as d4, a difference b4 between the outputs from the sensors 6 and 8 is given by:

b4=a4/αK×(1−1/√2×φJ−αK)+d4×(φK−αJ+1) (16)

The above-mentioned equations can be calculated only by combining equations (7) and (11), and their concepts are the same as in the first and second embodiments.

Since there are only two independent equations each including four variables: φK, αJ, αK, and φJ, their values must be estimated based on a certain assumption, as in the first and second embodiments. When estimated values φK′, αJ′, αK′, and φJ′ of the respective variables are obtained, correction can be performed by generating a coordinate transformation matrix which reflects these estimated values, and determining, as a measured value, a value obtained by multiplying the value output from a sensor by the coordinate transformation matrix.

Although specially limited setting of measurement points is done in the first and second embodiments for the sake of descriptive simplicity, correction according to the present invention can be performed as long as at least three measurement points which meet the following condition can be set. In other words, the condition is that three measurement points that are not set on the same line are adopted and can be continuously measured by all sensors in the process of movement among the respective measurement points. That three measurement points that are not set on the same line are adopted is a condition which makes equations (15) and (16) independent of each other. Also, that the three measurement points can be continuously measured by all sensors is a condition under which the distances between the respective measurement points can be calculated. This makes it possible to perform correction to reduce “the positional shift of the stage” in the process of movement of the stage 170 on the plane defined by the K- and J-axes.

### Fourth Embodiment

In the first to third embodiments, measurement points A to G are set on scales used for stage attitude measurement. For example, in an example illustrated in FIG. 6, since sensors 5, 7, and 8 are indicated by filled squares, corresponding scales 1, 3, and 4, respectively, are used for stage attitude measurement. On the other hand, a scale 2 is not used for stage attitude measurement and therefore is redundant. However, measurement points can be defined on scales regardless of whether they are used for stage attitude measurement.

Details of the fourth embodiment will be described with reference to FIG. 11. FIG. 11 corresponds to FIG. 8 in the first embodiment, but in the former measurement points A′ and B′ are defined on a scale 2. In other words, the fourth embodiment is different from the first embodiment in that in the former the output difference between measurement points in each of sensors 6 and 8 is calculated with reference to the measurement points A′ and B′ on the scale 2.

### Fifth Embodiment

Although an example in which the stage is moved to the positions, where the sensors face the measurement points A to G, to perform correction has been explained in the first to fourth embodiments, the present invention is not limited to this. As has been described in the third embodiment, each measurement point necessary for correction has a certain degree of freedom, so in case of an exposure apparatus, the stage is likely to pass through three points which meet the foregoing condition even during a normal exposure operation. Hence, the output from a sensor (for example, a sensor 6) which is always redundant during an exposure operation, and the values from sensors used for attitude measurement may be compared, and changes in scale attitude (φj, φK, αJ, αK) may be estimated based on the output differences when the stage passes through three points which meet the foregoing condition. This obviates the need to take the time for correction and therefore makes it possible to correct a measurement system as needed without degrading the productivity of the exposure apparatus.

### Sixth Embodiment

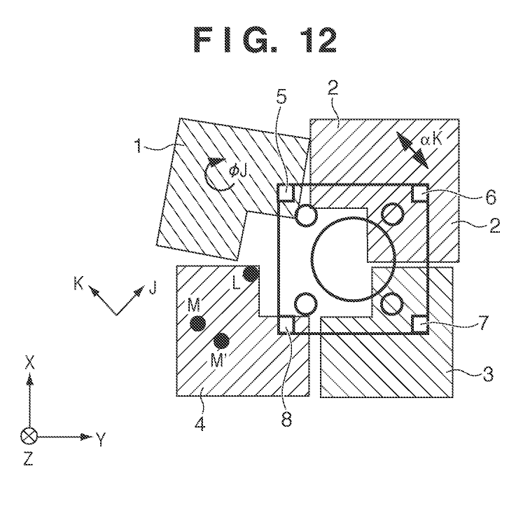

The sixth embodiment shows another method regarding the sequence in steps S1 to S5 of FIG. 7. The sixth embodiment has a feature that a reference point L with which an absolute position on a scale can be specified is provided, as shown in FIG. 12. The reference point L can be interpreted as that on a scale. By providing such a reference point, the value of an output difference b1 or b2 between sensors, which is generated due to “a positional shift of the stage” in the first and second embodiments, can be calculated with higher precision.

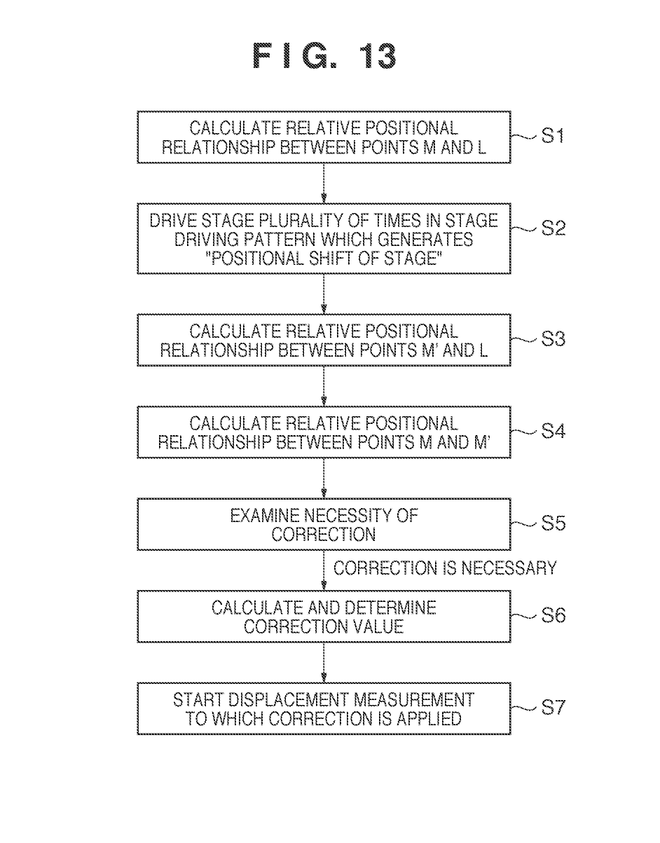

Details of the sixth embodiment will be described below with reference to a flowchart shown in FIG. 13. First, the relative relationship between a measurement point M and the reference point L is measured using sensors 5, 7, and 8 and scales 1, 3, and 4 (S1). Next, a stage 170 is driven a plurality of times in a stage driving pattern which generates “a positional shift of the stage”. For example, a stage driving pattern as described with reference to FIGS. 5A to 5G is repeated n times (S2). At this time, the scales and sensors are switched as needed in accordance with the stage driving pattern. After that, the stage 170 moves to a position corresponding to the measurement point M, but this results in incorrectly moving it to a measurement point M′ due to “a positional shift of the stage”. In view of this, the positional relationship between the reference point L and the measurement point M′ is measured (S3), and the positional relationship between the measurement points M and M′ is indirectly calculated (S4). This makes it possible to obtain a value which is n times that corresponding to the output difference between the sensors in the first embodiment, and therefore is more precise than b1. In other words, the larger the number of times n, the higher the measurement precision becomes. This method intentionally accumulates an error without changing the sensor precision to improve the measurement precision, that is, the correction accuracy. After that, the necessity of correction in a measurement system is examined based on the measured value (corresponding to n×b1) (S5). If it is determined that correction is necessary, the amount of scale change is estimated, as described in, for example, the first embodiment, to calculate and determine the amount of correction (S6). This amount of correction is often defined by a coordinate transformation matrix. After that, displacement measurement for which correction is performed based on the amount of correction is started (S7).

Note that as a matter of course, the stage driving pattern used in step S2 is not limited to that as shown in FIGS. 5A to 5G, and can take any form as long as it generates “a positional shift of the stage” and allows an error to accumulate upon its repetition.

### Application Example

A device manufacturing method according to an embodiment of the present invention is suitable for manufacturing devices such as a semiconductor device and a liquid crystal device. The method can include a step of exposing a substrate coated with a photosensitive agent using the above-mentioned exposure apparatus, and a step of developing the exposed substrate. The device manufacturing method can also include subsequent known steps (for example, oxidation, film formation, vapor deposition, doping, planarization, etching, resist removal, dicing, bonding, and packaging).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-201083, filed Aug. 31, 2009, which is hereby incorporated by reference herein in its entirety.

What is claimed is:

1. A measurement apparatus which includes a plurality of sensors arranged on a movable member, and a plurality of scales attached to a structure, and measures a position of the movable member by detecting a displacement of the movable member using a sensor and a scale that face each other,
the plurality of scales including
two first scales configured to detect displacements of the movable member in a first direction, and two second scales configured to detect displacements of the movable member in a second direction different from the first direction, and
the apparatus comprising
a controller configured to reduce a measurement error resulting from a geometrical error between the two first scales based on a difference between displacements detected by two sensors, respectively, facing the two first scales when the movable member moves from a first position to a second position so that values detected by two sensors facing the two second scales when the movable member is at the first position become equal to values detected by the two sensors facing the two second scales when the movable member is at the second position.

2. The apparatus according to claim 1, wherein
a movable area of the movable member includes a first region where one of the two first scales faces a sensor, but the other one of the two first scales faces no sensor, and a second region where the one of the two first scales faces no sensor, but the other one of the two first scales faces a sensor, and
a first scale, used to detect a displacement of the movable member, of the two first scales is changed when the movable member moves from the first region to the second region and when the movable member moves from the second region to the first region.

3. The apparatus according to claim 1, wherein the geometrical error includes a difference between array pitches of diffraction gratings formed in the two first scales, respectively.

4. The apparatus according to claim 1, wherein the geometrical error includes a difference between rotation angles of the two first scales.

5. The apparatus according to claim 1, wherein
a first line parallel to the first direction, and a second line parallel to the second direction, intersect at right angles at a given point,
the two first scales are arranged to sandwich the given point therebetween on the second line, and
the two second scales are arranged to sandwich the given point therebetween on the first line.

6. An exposure apparatus which projects a pattern of an original onto a substrate by a projection optical system to expose the substrate, the apparatus comprising
a movable member t configured to hold the substrate;
a measurement apparatus which includes a plurality of sensors arranged on a movable member, and a plurality of scales attached to a structure, and measures a position of the movable member by detecting a displacement of the movable member using a sensor and a scale that face each other,
the plurality of scales including
two first scales configured to detect displacements of the movable member in a first direction, and two second scales configured to detect displacements of the movable member in a second direction different from the first direction, and
the apparatus comprising
a controller configured to reduce a measurement error resulting from a geometrical error between the two first scales based on a difference between displacements detected by two sensors, respectively, facing the two first scales when the movable member moves from a first position to a second position so that values detected by two sensors facing the two second scales when the movable member is at the first position become equal to values detected by the two sensors facing the two second scales when the movable member is at the second position.

7. A device manufacturing method comprising the steps of:
exposing a substrate using an exposure apparatus; and
developing the substrate,
wherein the exposure apparatus is configured to project a pattern of an original onto a substrate by a projection optical system to expose the substrate, and comprises
a movable member t configured to hold the substrate;
a measurement apparatus which includes a plurality of sensors arranged on a movable member, and a plurality of scales attached to a structure, and measures a position of the movable member by detecting a displacement of the movable member using a sensor and a scale that face each other,
the plurality of scales including
two first scales configured to detect displacements of the movable member in a first direction, and two second scales configured to detect displacements of the movable member in a second direction different from the first direction, and
the apparatus comprising
a controller configured to reduce a measurement error resulting from a geometrical error between the two first scales based on a difference between displacements detected by two sensors, respectively, facing the two first scales when the movable member moves from a first position to a second position so that values detected by two sensors facing the two second scales when the movable member is at the first position become equal to values detected by the two sensors facing the two second scales when the movable member is at the second position.
